(19) United States
(12) Patent Application Publication
(10) Pub. No.: US 2014/0345534 A1
(43) Pub. Date: Nov. 27, 2014

(54) Livestock Feeder-Embedded RFID Antenna Apparatus

(71) Applicant: Hana Micron America Inc., Milpitas, CA (US)

(72) Inventors: Seungwhan Rhee, Milpitas, CA (US); Songtao Jin, Milpitas, CA (US)

(73) Assignee: Hana Micron America Inc., Milpitas, CA (US)

(21) Appl. No.: 13/902,938

(22) Filed: May 27, 2013

(51) Int. Cl. A01K 29/00; G06K 19/077; A01K 5/01

(52) U.S. Cl. CPC A01K 29/005; A01K 5/0114; G06K 19/07773
USPC 119/61.5

(57) ABSTRACT

Several embodiments of a novel RFID antenna apparatus that are uniquely structurally integrated with livestock feeder units are disclosed. In one embodiment, a circular antenna apparatus embeds a circular livestock feeder unit by structurally encapsulating or surrounding a perimeter of the circular livestock feeder unit. In another embodiment, a rectangular antenna similarly embeds a rectangular livestock feeder unit by structurally encapsulating or surrounding a perimeter of the rectangular livestock feeder unit. Preferably, the circular or the rectangular antenna apparatus also includes a protective pipe or an outer skin layer that incorporates an RF antenna feed point, an antenna core, an impedance matching circuit, and a coaxial RF connector inside the protective pipe or the outer skin layer. The novel livestock feeder-embedded RFID antenna apparatuses improve accuracy of animal RFID tag reading, while also minimizing tuning time and reinstallation efforts associated with an RFID-based livestock monitoring system.

### BACKGROUND OF THE INVENTION

The present invention generally relates to radio frequency (RF) antenna designs. More specifically, the present invention relates to one or more embodiments of livestock feeder-embedded radio frequency identification (RFID) antenna apparatuses, which are utilized in animal-identifying electronic systems. The present invention also relates to one or more embodiments of an early alert system for livestock disease detection with an activity measurement zone (AMZ) defined by particular configurations of RFID antenna designs. Furthermore, the present invention also relates to an early detection of a contagious disease in farm animals using a livestock feeder that embeds one or more embodiments of RFID antenna apparatuses of the present invention.

Conventional RFID antenna designs for animal-identifying electronic systems generally do not provide an optimized level of animal detection accuracy. Accurate detection of livestock animals is especially challenging using conventional long frequency-based (LF-based) animal detection systems, which are generally unable to read a multiple number of tags in a particular RFID detection zone. Moreover, even if newer ultra high frequency-based (UHF-based) RFID solutions are used for livestock animal detection systems that accommodate simultaneous RFID tag accesses, conventional UHF RFID antenna designs struggle to provide a precisely-defined zone of animal detection when the ease of installation or the durability of the UHF RFID antenna is taken into account.

For example, if a conventional UHF RFID antenna were to define an animal activity measurement zone (AMZ) for a livestock water bunk or a food feeder box, the conventional UHF RFID antenna is typically installed above the AMZ by attaching the conventional UHF RFID antenna to a vertical pole near the livestock water bunk or the food feeder. However, by suspending the UHF RFID antenna substantially high above (e.g. 6˜10 feet) the ground where a precise boundary of the AMZ is desired, the conventional UHF RFID antenna requires time-consuming and labor-intensive zone-tuning processes that hamper efficient and cost-effective animal monitoring system deployments. Furthermore, if livestock animals are relocated from one housing or facility to another, the zone-tuning process has to be repeated for each livestock relocation procedure. Equally important, the durability of the suspended RFID antenna is less than desirable, as heavy livestock animals, such as cows, pigs, and horses, can bump into the vertical pole where the UHF RFID antenna is attached.

In another example of conventional RFID antenna installation for animal detection systems, a conventional UHF RFID antenna can be placed underneath a livestock water bunk or a food feeder. However, this method makes the conventional UHF RFID antenna susceptible to touching or nearly touching earthly elements on the ground, which reduces the operational durability of the conventional UHF RFID antenna. Furthermore, shapes, dimensions, and thicknesses of various livestock water bunks and food feeders vary from one facility to another, which make defining an accurate boundary of an animal activity measurement zone (AMZ) difficult, time-consuming, and costly for livestock farm owners and animal detection system installers.

Because conventional RFID antenna designs are generally difficult to fine-tune for defining a precise boundary of an animal activity measurement zone, it may be desirable to devise specialized RFID antenna designs that can accurately define animal activity measurement zones. Furthermore, because conventional RFID antenna designs are also generally inconvenient and inefficient for reinstallation after livestock animals relocate from one facility to another, it may be desirable to devise specialized RFID antenna designs that can easily and conveniently accommodate reinstallation of RFID antennas in various livestock farming facilities. In addition, it may also be desirable to devise specialized RFID antenna designs that are durable for various weather and outdoor conditions and livestock movement-related wear-and-tear. Moreover, it may also be desirable to devise specialized RFID antenna designs that are cost effective for manufacturing, installation, and repeated usage.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, an RFID antenna apparatus is disclosed. This RFID antenna apparatus comprises: an antenna core forming a circular shape with a first end of the antenna core electrically connected to an antenna feed point and a second end of the antenna core also electrically connected to the antenna feed point; an impedance matching circuit electrically connected to the antenna core; a coaxial RF connector electrically connected to the impedance matching circuit and an RFID reading device to transmit RF signals; the antenna feed point containing the coaxial RF connector; an antenna outer surface made of a pipe or a protective outer skin layer, wherein the antenna outer surface encapsulates the antenna core, the impedance matching circuit, and the coaxial RF connector to provide weatherproofing and other wear-and-tear-related protection to internal components of the RFID antenna apparatus; and a circular livestock feeder bowl with a sidewall and a livestock feed-containing area, wherein the circular livestock feeder bowl is structurally incorporated and embedded by the antenna outer surface that contains the antenna core, the impedance matching circuit, and the coaxial RF connector.

In another embodiment of the invention, another RFID antenna apparatus is disclosed. This RFID antenna apparatus comprises: an antenna core forming a rectangular shape with a first end of the antenna core electrically connected to an antenna feed point and a second end of the antenna core also electrically connected to the antenna feed point; an impedance matching circuit electrically connected to the antenna core; a coaxial RF connector electrically connected to the impedance matching circuit and an RFID reading device to transmit RF signals; the antenna feed point containing the coaxial RF connector; an antenna outer surface made of a pipe or a protective outer skin layer, wherein the antenna outer surface encapsulates the antenna core, the impedance matching circuit, and the coaxial RF connector to provide weatherproofing and other wear-and-tear-related protection to internal components of the RFID antenna apparatus; and a rectangular livestock feeder bowl with a sidewall and a livestock feed-containing area, wherein the rectangular livestock feeder bowl is structurally incorporated and embedded by the antenna outer surface that contains the antenna core, the impedance matching circuit, and the coaxial RF connector.

### BRIEF DESCRIPTION OF DRAWINGS

FIG. 1 shows a perspective view of a livestock feeder-embedded circular antenna apparatus in accordance with an embodiment of the invention.

FIG. 2 shows an interior diagram of a livestock feeder-embedded circular RFID antenna apparatus in accordance with an embodiment of the invention.

FIG. 3 shows a circular feeder bowl-embedded circular RFID antenna apparatus in accordance with an embodiment of the invention.

FIG. 4 shows a magnified perspective view of a circular feeder bowl-embedded circular RFID antenna apparatus in accordance with an embodiment of the invention.

FIG. 5 shows a livestock feeder-embedded rectangular antenna apparatus in accordance with an embodiment of the invention.

FIG. 6 shows another livestock feeder-embedded rectangular antenna apparatus in accordance with an embodiment of the invention.

FIG. 7 shows an interior diagram of a livestock feeder-embedded rectangular RFID antenna apparatus in accordance with an embodiment of the invention.

FIG. 8 shows a rectangular feeder bowl-embedded rectangular RFID antenna apparatus in accordance with an embodiment of the invention.

FIG. 9 shows a cross section of an antenna outer surface of a livestock feeder-embedded RFID antenna apparatus in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more livestock feeder-embedded RFID antenna apparatuses. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

For the purpose of describing the invention, a term “livestock” is defined as farm animals raised for use and/or profit. The term “livestock” can include, but are not limited to, cattle, sheep, pigs, goats, horses, donkeys, mules, and poultry (e.g. chickens, ducks, turkeys, and geese).

Furthermore, for the purpose of describing the invention, a term “activity measurement zone” (AMZ) is defined as a designated area in which the entrance and/or the exit of a monitored animal in an accurately-defined area is counted and tracked by an RFID tag attached to the monitored animal and an RFID antenna connected to a RFID reading device. In a preferred embodiment of the invention, the RFID reading device is operatively connected to or incorporated into a livestock feeder-embedded antenna apparatus. Preferably, the RFID reading device is an RFID tag reader unit or another RFID tag access controlling unit, which is operatively connected to the livestock feeder-embedded antenna apparatus. In the preferred embodiment of the invention, the livestock feeder-embedded RFID antenna has an RFID tag access range custom-tuned to a perimeter within the surrounding borders of the livestock feeder, which is typically a circular bowl or a rectangular bowl. In the preferred embodiment of the invention, an animal activity measurement zone (AMZ) can be precisely defined within the exterior dimensions of a circular or rectangular livestock feeder. The livestock feeder can serve as an incentive device for the AMZ of an early alert system for livestock animal disease monitoring.

In addition, for the purpose of describing the invention, a term “livestock feeder” is defined as a container, a bowl, a plate, or another animal feed-holding apparatus, which can be accessed by an animal to fetch animal feed and/or water. In one example, a livestock feeder may contain animal feed. In another example, a livestock feeder may be a water bowl or a water-dispensing device for livestock animals.

Furthermore, for the purpose of describing the invention, a term “antenna apparatus” is defined as an electrical device that contains a body of a radio frequency (RF) antenna and any other desirable components, such as an antenna feed point, an impedance-matching circuit, an antenna core, and/or a coaxial RF connector, such as SMA connectors (SubMiniature version A).

Furthermore, for the purpose of describing the invention, a term “livestock feeder-embedded” is defined as “being attached to” or “being incorporated into” a livestock feeder unit used in livestock farming.

In addition, for the purpose of describing the invention, a term “radio frequency identification,” or RFID, is defined as a wireless signal-based identification of a wirelessly-accessible tag, called an “RFID tag” using a wirelessly-accessible tag reader, called “RFID tag reader,” “RFID reading device,” or “RFID reader. In general, an RFID tag contains information which may be written and/or read by the RFID tag reader, an RFID antenna operatively connected to the RFID tag reader, or another tag information access device. In a preferred embodiment of the invention, RFID operates in ultra high frequencies (UHF) to achieve multiple tag read and write capabilities, which were difficult to achieve in conventional low frequency (LF)-based RFID devices exhibiting a serialized (i.e. singular) tag read and write functionalities. In a preferred embodiment of the invention, the UHF range for the RFID tag reader is defined by ISO/IEC 18000-6 air interface standard, which utilizes an operating frequency range of 860 MHz˜960 MHz. In another embodiment of the invention, the UHF operating frequency range may be defined more broadly as 300 MHz˜3 GHz. In general, the conventional LF operating frequencies are below the UHF RFID tag reader operating frequency ranges.

One aspect of an embodiment of the present invention is providing a novel and highly-durable livestock feeder-embedded RFID antenna apparatus that can be used in an early alert system for livestock disease detection.

Another aspect of an embodiment of the present invention is providing a novel livestock feeder-embedded RFID antenna apparatus that is easy to relocate and reinstall with minimal time consumption and fine-tuning effort for each activity measurement zone (AMZ) for tracking of livestock animals.

Yet another aspect of an embodiment of the present invention is utilizing a novel concept of an activity measurement zone (AMZ) in conjunction with a novel livestock feeder-embedded antenna apparatus for precise detection of animals accessing a livestock feeder for food or water.

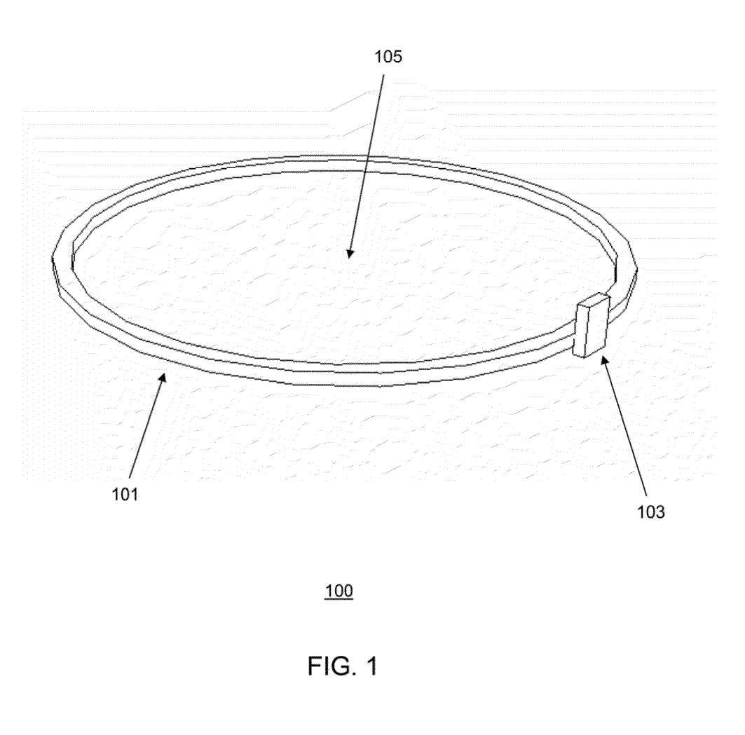

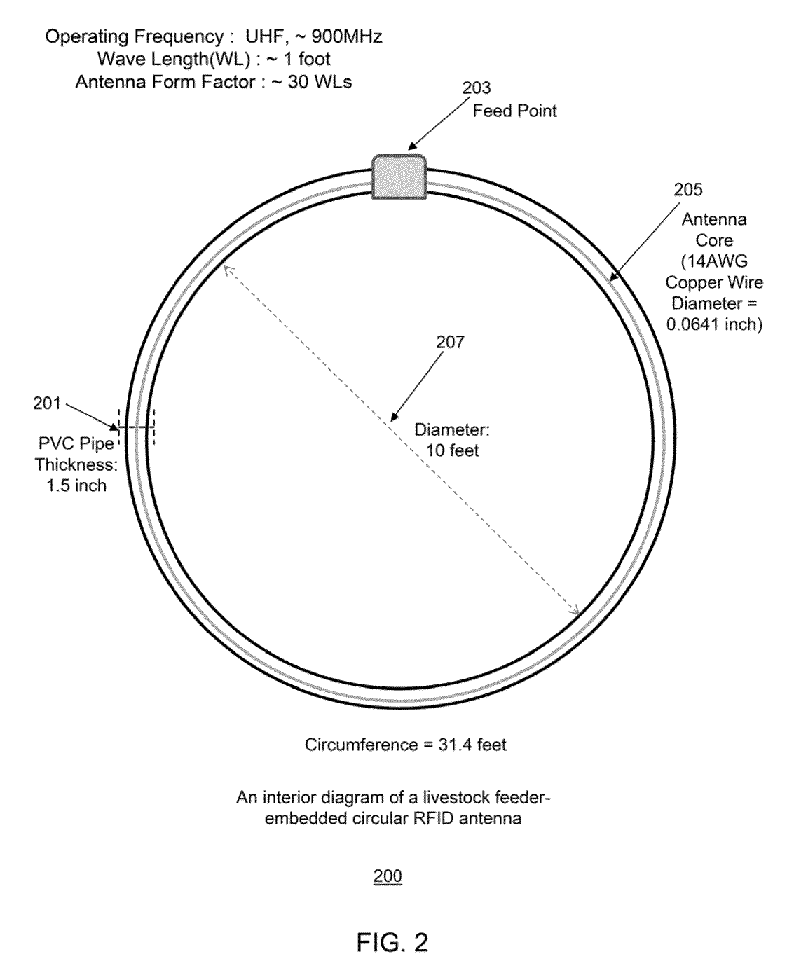

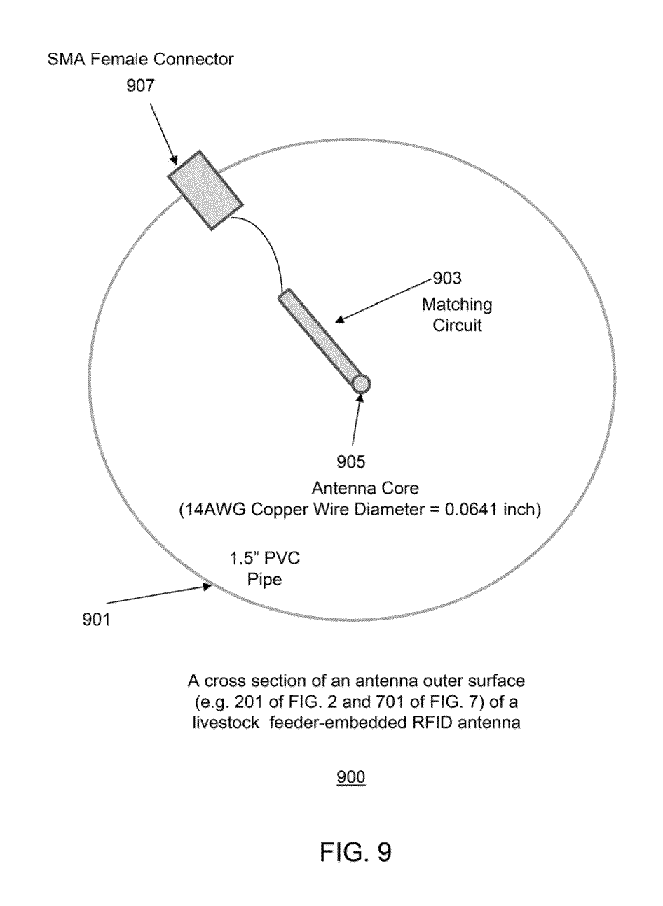

FIG. 1 shows a perspective view of a livestock feeder-embedded circular antenna apparatus (100) in accordance with an embodiment of the invention. In a preferred embodiment of the invention, surface portions of the livestock feeder-embedded circular antenna apparatus (100) comprise an antenna outer surface (101), an antenna feed point (103), and a circular cavity (105). In one embodiment of the invention, the antenna outer surface (101) is made out of polyvinyl chloride (PVC) materials. The PVC materials may be in form of a pipe made of PV materials, or a PVC-based skin layer that surrounds or encapsulates inner materials of the livestock feeder-embedded circular antenna apparatus, which are further elaborated in FIG. 2 and FIG. 9. In another embodiment of the invention, the antenna outer surface (101) is made out of other plastic materials, rubber materials, synthetic fabric materials, or other appropriate materials that provide durable internal component protection and weather-proof protection against external elements such as moisture, dust, and soil.

Furthermore, in a preferred embodiment of the invention, the antenna feed point (103) is utilized to connect a signal source originating from an RFID reading device to the rest of the livestock feeder-embedded circular antenna apparatus (100). Typically, an impedance matching circuit is integrated inside the livestock feeder-embedded circular antenna apparatus (100) or is operatively connected to the livestock feeder-embedded circular antenna apparatus (100) to achieve optimized signal propagation and RFID tag-reading sensitivities. In addition, in one embodiment of the invention, a symmetrical or asymmetrical gap may optionally be present in the antenna outer surface (101) for highly-effective RFID tag reading range and antenna sensitivities around the circumference of a circular livestock feeder bowl or a circular livestock feeder container that becomes embedded in the structure of the RFID antenna apparatus. If a symmetrical or asymmetrical gap is present in the antenna outer surface (101), then the livestock feeder-embedded circular antenna apparatus (100) is effectively a dipole antenna structure. On the other hand, if there is no symmetrical or asymmetrical gap in the antenna outer surface (101), then the livestock feeder-embedded circular antenna apparatus (100) is effectively a loop antenna structure.

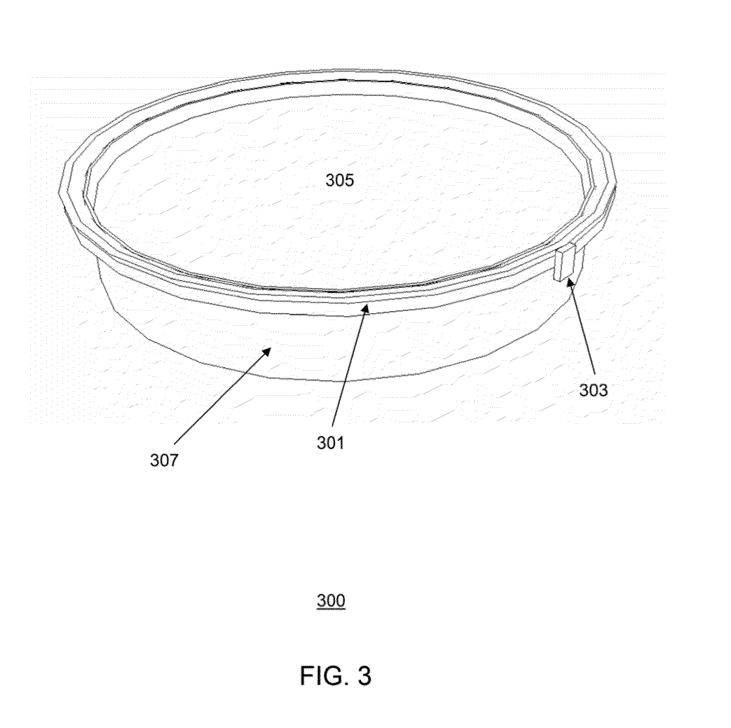

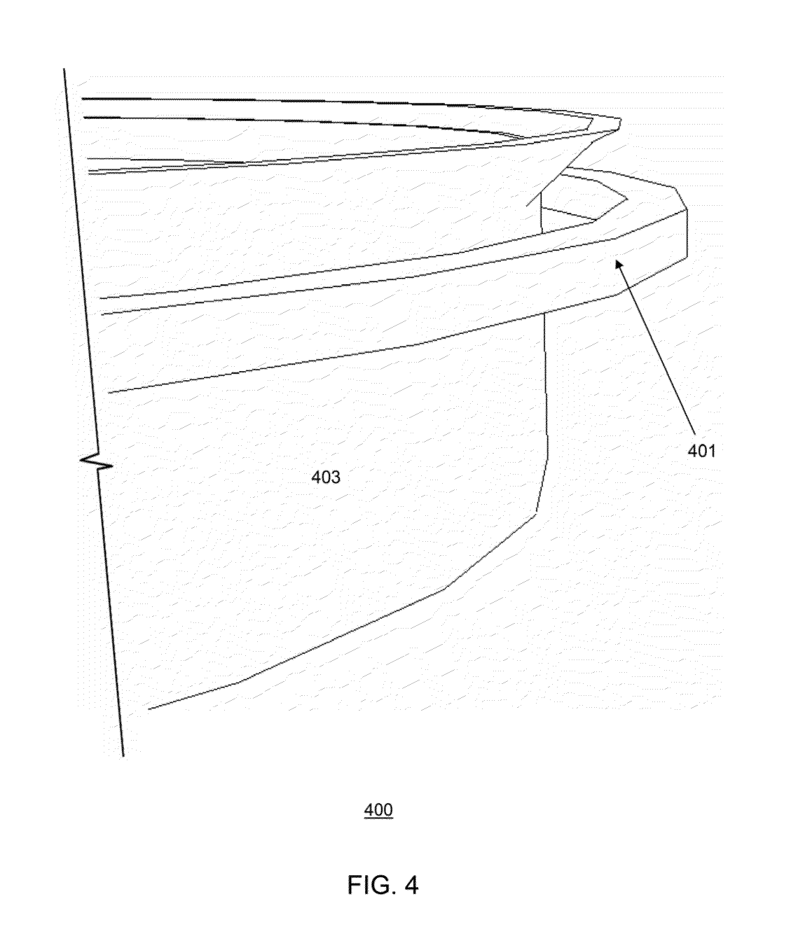

Continuing with FIG. 1, the circular cavity (105) is uniquely designed to accommodate, integrate, surround, and/or encapsulate a circular livestock feeder bowl, a circular livestock feeder container, or another livestock feeder device that is configured to place water or food for livestock animals in livestock farming environment, such as a cattle ranch, a chicken farm, or another livestock farm ranch. Circular livestock feeders with uniquely-integrated RFID antenna apparatuses in accordance with various embodiments of the present invention are shown in FIG. 3 and FIG. 4, for example.

FIG. 2 shows an interior diagram (200) of a livestock feeder-embedded circular RFID antenna apparatus in accordance with an embodiment of the invention. In the embodiment of the invention as shown in FIG. 2, the livestock feeder-embedded circular RFID antenna apparatus comprises a PVC pipe (201) with approximately 1.5-inch thickness, an antenna feed point (203), and an antenna core (205), which is made of a 14 AWG (American wire gauge) copper wire with a wire diameter of approximately 0.0641 inch.

As shown in FIG. 2, the PVC pipe (201) encapsulates or surrounds the antenna core (205) for electrical insulation and weatherproofing-related protection. Moreover, in this particular embodiment of the invention, the diameter (207) of the livestock feeder-embedded circular RFID antenna can be approximately 10 feet, and the circumference of the livestock feeder-embedded circular RFID antenna can be approximately 31.4 feet. In addition, in one embodiment of the invention, the operating frequency of the livestock feeder-embedded circular RFID antenna is approximately 900 MHz (i.e. a UHF range), and the wavelength may be approximately 1 foot. Furthermore, the antenna form factor may be approximately 30 WLs.

Furthermore, in a preferred embodiment of the invention, the PVC pipe (201) can further contain an impedance matching circuit (e.g. 903 of FIG. 9) and a coaxial RF connector (e.g. 907), which are operatively connected to the antenna core (205) situated near the center of a cross section of the PVC pipe (201). In another embodiment of the invention, the livestock feeder-embedded circular RFID antenna may have a different diameter and a different PVC pipe thickness to accommodate a particular dimension (e.g. diameter, circumference, shape, and etc.) of a livestock feeder bowl's sidewall or a livestock feeder container's sidewall. Yet in another embodiment of the invention, a plastic, rubber, or synthetic material-based outer skin layer may encapsulate or surround the antenna core (205) instead of the PVC pipe (201), depending on particular design and operational requirements.

FIG. 3 shows a circular feeder bowl-embedded circular RFID antenna apparatus (300) in accordance with an embodiment of the invention. In this embodiment of the invention as shown in FIG. 3, an antenna outer surface (301) and an antenna feed point (303) surround a bordering perimeter of a circular feeder bowl's sidewall (307). By surrounding the bordering perimeter of the circular feeder bowl's sidewall (307), the circular feeder bowl-embedded circular RFID antenna apparatus (300) is able to accurately and precisely define an animal activity measurement zone (AMZ) as a feed-containing area (305). Therefore, false RFID tag access rates for animal monitoring purposes are substantially lowered by the structural uniqueness and the novelty of the circular feeder bowl-embedded circular RFID antenna apparatus (300) disclosed as an embodiment of the present invention. Furthermore, by structurally integrating a circular feeder bowl (e.g. 307) with a circular RFID antenna apparatus as a single physical unit, the portability of the AMZ defined by the feed-containing area is greatly improved over conventional RFID antennas that are mounted on a vertical post or placed on a non-portable ground object. Moreover, any relocations and reinstallations of livestock monitoring system in various livestock housings are greatly simplified with reduced tuning and installation time and effort for livestock farms.

Continuing with FIG. 3, the feed-containing area (305) may contain animal feed or water for livestock animals, such as cattle, chickens, pigs, ducks, and other livestock animals. In one embodiment of the invention, the circular feeder bowl and its sidewall (307) is made of durable plastic materials. In another embodiment of the invention, the circular feeder bowl and its sidewall (307) is made of rubber or synthesized materials. Yet in another embodiment of the invention, the circular feeder bowl and its sidewall (307) is made of metals or alloys.

Furthermore, in a preferred embodiment of the invention, the antenna outer surface (301) comprises a circular PVC pipe that encapsulates or surrounds an antenna core inside the antenna outer surface (301), as illustrated in FIG. 2. In another embodiment of the invention, the antenna outer surface (301) comprises an outer skin layer made of plastic, rubber, and/or synthetic materials that encapsulate or surround the antenna core inside the antenna outer surface (301), depending on particular design and operational requirements.

Moreover, as also described in association with FIG. 1, the antenna feed point (303) for the embodiment of the invention as shown in FIG. 3 is utilized to connect a signal source originating from an RFID reading device to the rest of the circular feeder bowl-embedded circular RFID antenna apparatus (300). Typically, an impedance matching circuit is integrated inside the circular feeder bowl-embedded circular RFID antenna apparatus (300), or is operatively connected to the circular feeder bowl-embedded circular RFID antenna apparatus (300) to achieve optimized signal propagation and RFID tag-reading sensitivities.

FIG. 4 shows a magnified perspective view (400) of a circular feeder bowl-embedded circular RFID antenna apparatus in accordance with an embodiment of the invention. In the magnified perspective view (400) for an embodiment of the invention as shown in FIG. 4, an antenna outer surface (401) of the circular feeder bowl-embedded circular RFID antenna apparatus surrounds or encapsulates the bordering perimeter of a circular feeder bowl sidewall (403). The thickness of the antenna outer surface (401) can vary depending on design and application requirements. In one embodiment of the invention, the antenna outer surface (401) is made of a PVC pipe, which is approximately 1.5-inch thick. The antenna outer surface (401) typically contains an antenna core, a matching circuit, and a coaxial RF connector inside the antenna outer surface (401) to enable precise RFID tag reading within the perimeter of the circular feeder bowl sidewall (403) for animal activity monitoring associated with livestock feeding behaviors and livestock water consumption.

In one embodiment of the invention, the antenna outer surface (401) of the circular feeder bowl-embedded circular RFID antenna apparatus is physically attached to the circular feeder bowl sidewall (403) with attachment bars, screws, epoxy, and/or other attachment-enabling components. In another embodiment of the invention, the antenna outer surface (401) of the circular feeder bowl-embedded circular RFID antenna apparatus is configured to fit the circular feeder bowl sidewall (403) firmly and tightly, once the antenna outer surface (401) is slid into a designated position. Furthermore, in one embodiment of the invention, the circular feeder bowl-embedded circular RFID antenna apparatus is manufactured and sold as a single unit from a factory from the outset. In another embodiment of the invention, the main body of the circular feeder bowl and the circular RFID antenna apparatus are manufactured and sold separately, and later attached together by a livestock farm worker, a livestock monitoring system installer, or another authorized personnel.

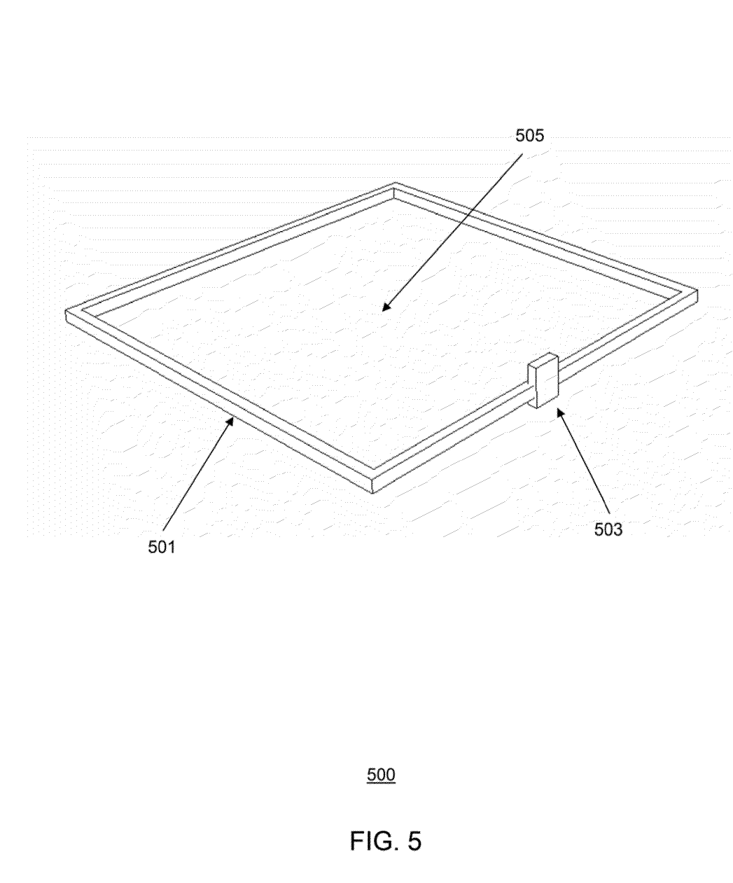

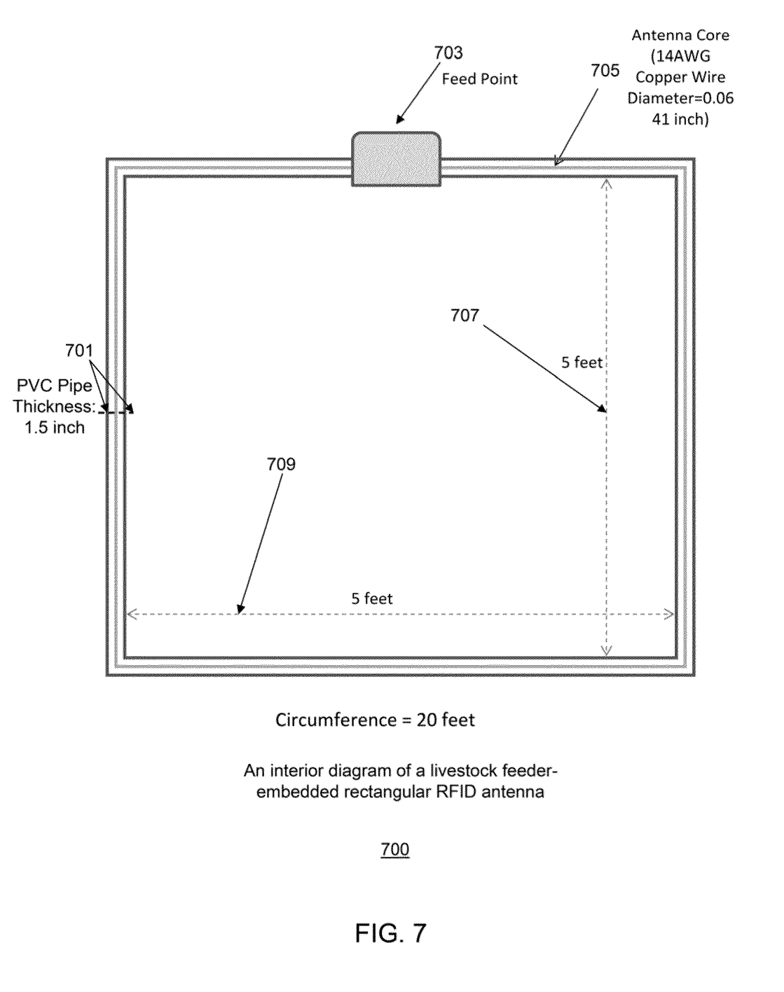

FIG. 5 shows a livestock feeder-embedded rectangular antenna apparatus (500) in accordance with an embodiment of the invention. In a preferred embodiment of the invention, surface portions of the livestock feeder-embedded rectangular antenna apparatus (500) comprise an antenna outer surface (501), an antenna feed point (503), and a rectangular cavity (505). In one embodiment of the invention, the antenna outer surface (501) is made out of polyvinyl chloride (PVC) materials. The PVC materials may be in form of a pipe made of PV materials, or a PVC-based skin layer that surrounds or encapsulates inner materials of the livestock feeder-embedded rectangular antenna apparatus, which are further elaborated in FIG. 7 and FIG. 9. In another embodiment of the invention, the antenna outer surface (501) is made out of other plastic materials, rubber materials, synthetic fabric materials, or other appropriate materials that provide durable internal component protection and weather-proof protection against external elements such as moisture, dust, and soil.

Furthermore, in a preferred embodiment of the invention, the antenna feed point (503) is utilized to connect a signal source originating from an RFID reading device to the rest of the livestock feeder-embedded rectangular antenna apparatus (500). Typically, an impedance matching circuit is integrated inside the livestock feeder-embedded rectangular antenna apparatus (500) or is operatively connected to the livestock feeder-embedded rectangular antenna apparatus (500) to achieve optimized signal propagation and RFID tag-reading sensitivities.

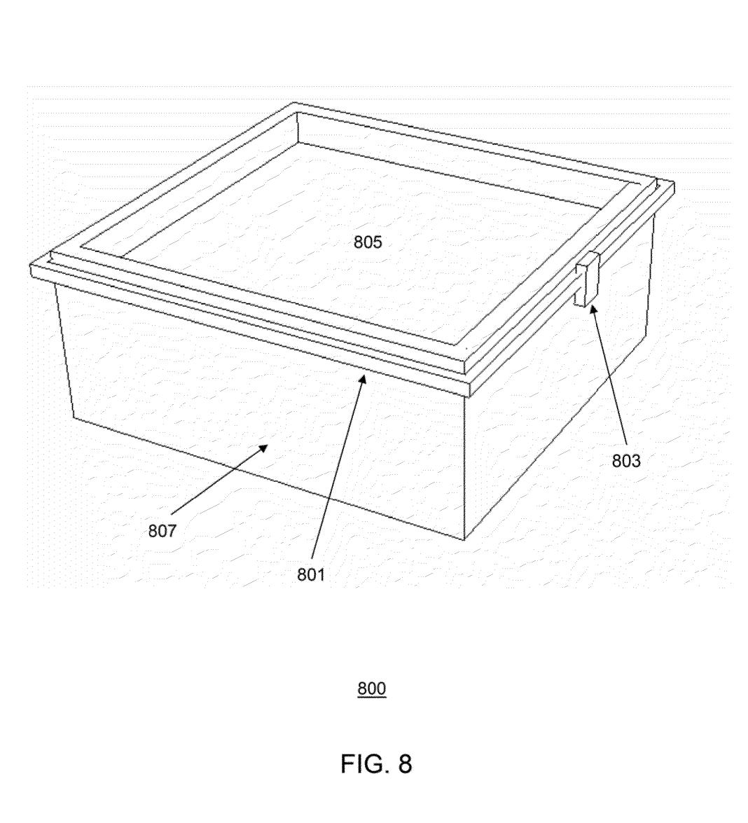

Continuing with FIG. 5, the rectangular cavity (505) is uniquely designed to accommodate, integrate, surround, and/or encapsulate a rectangular livestock feeder bowl, a rectangular livestock feeder container, or another livestock feeder device that is configured to place water or food for livestock animals in livestock farming environment, such as a cattle ranch, a chicken farm, or another livestock farm ranch. Rectangular livestock feeders with uniquely-integrated RFID antenna apparatuses in accordance with various embodiments of the present invention are shown in FIG. 8, for example.

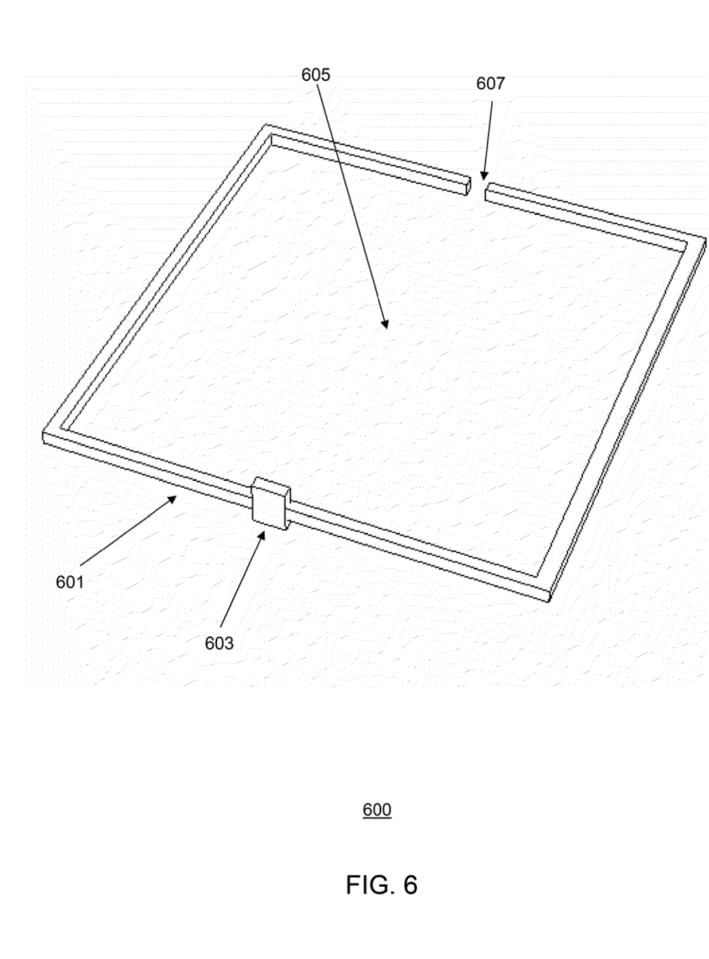

FIG. 6 shows another livestock feeder-embedded rectangular antenna apparatus (600) in accordance with an embodiment of the invention. Unlike the embodiment of the invention as shown in FIG. 6, the livestock feeder-embedded rectangular antenna apparatus (600) has a symmetrical gap (607) on one edge of the livestock feeder-embedded rectangular antenna apparatus (600) for highly-effective RFID tag reading range and antenna sensitivities around a perimeter of a rectangular livestock feeder bowl. In one embodiment of the invention, this symmetrical gap (607) is on an opposite edge of another edge that contains an antenna feed point (603), as shown in FIG. 6. In another embodiment of the invention, the symmetrical gap (607) may be placed on another edge regardless of the location of the antenna feed point (603). Yet in another embodiment of the invention, the gap may be asymmetrical for the livestock feeder-embedded rectangular antenna apparatus (600). Furthermore, if a symmetrical or asymmetrical gap is present in the antenna outer surface (601) as shown in FIG. 6, then the livestock feeder-embedded rectangular antenna apparatus (600) is effectively a dipole antenna structure. On the other hand, if there is no symmetrical or asymmetrical gap in the antenna outer surface (601), then the livestock feeder-embedded rectangular antenna apparatus (600) is effectively a loop antenna structure.

Continuing with FIG. 6, in one embodiment of the invention, surface portions of the livestock feeder-embedded rectangular antenna apparatus (600) comprise an antenna outer surface (601), an antenna feed point (603), a rectangular cavity (605), and a symmetrical gap (607). In one embodiment of the invention, the antenna outer surface (601) is made out of polyvinyl chloride (PVC) materials. The PVC materials may be in form of a pipe made of PV materials, or a PVC-based skin layer that surrounds or encapsulates inner materials of the livestock feeder-embedded rectangular antenna apparatus, which are further elaborated in FIG. 7 and FIG. 9. In another embodiment of the invention, the antenna outer surface (601) is made out of other plastic materials, rubber materials, synthetic fabric materials, or other appropriate materials that provide durable internal component protection and weather-proof protection against external elements such as moisture, dust, and soil.

Furthermore, in a preferred embodiment of the invention, the antenna feed point (603) is utilized to connect a signal source originating from an RFID reading device to the rest of the livestock feeder-embedded rectangular antenna apparatus (600). Typically, an impedance matching circuit is integrated inside the livestock feeder-embedded rectangular antenna apparatus (600) or is operatively connected to the livestock feeder-embedded rectangular antenna apparatus (600) to achieve optimized signal propagation and RFID tag-reading sensitivities.

Continuing with FIG. 6, the rectangular cavity (605) is uniquely designed to accommodate, integrate, surround, and/or encapsulate a rectangular livestock feeder bowl, a rectangular livestock feeder container, or another livestock feeder device that is configured to place water or food for livestock animals in livestock farming environment, such as a cattle ranch, a chicken farm, or another livestock farm ranch. Rectangular livestock feeders with uniquely-integrated RFID antenna apparatuses in accordance with various embodiments of the present invention are shown in FIG. 8, for example.

FIG. 7 shows an interior diagram (700) of a livestock feeder-embedded rectangular RFID antenna apparatus in accordance with an embodiment of the invention. In the embodiment of the invention as shown in FIG. 7, the livestock feeder-embedded rectangular RFID antenna apparatus comprises a PVC pipe (701) with approximately 1.5-inch thickness, an antenna feed point (703), and an antenna core (705), which is made of a 14 AWG (American wire gauge) copper wire with a wire diameter of approximately 0.0641 inches. In addition, in one embodiment of the invention, the operating frequency of the livestock feeder-embedded rectangular RFID antenna is approximately 900 MHz (i.e. a UHF range), and the wavelength may be approximately 1 foot.

As shown in FIG. 7, the PVC pipe (701) encapsulates or surrounds the antenna core (705) for electrical insulation and weatherproofing-related protection. Moreover, in this particular embodiment of the invention, each side edge (707, 709) of the livestock feeder-embedded rectangular RFID antenna apparatus can be approximately 5 feet long, thereby forming a square antenna shape. In another embodiment of the invention, a first pair of opposite-faced side edges may have a different length from a second pair of opposite-faced side edges, thereby forming a non-squarely rectangle for the shape of the livestock feeder-embedded rectangular RFID antenna apparatus. Furthermore, in the embodiment of the invention as shown in FIG. 7, the total perimeter lengths can be approximately 20 feet, with approximately 5 feet on each side.

Furthermore, in a preferred embodiment of the invention, the PVC pipe (701) can further contain an impedance matching circuit (e.g. 903 of FIG. 9) and a coaxial RF connector (e.g. 907), which are operatively connected to the antenna core (705) situated near the center of a cross section of the PVC pipe (701). In another embodiment of the invention, the livestock feeder-embedded rectangular RFID antenna may have a different dimension and a different PVC pipe thickness to accommodate a particular design of a livestock feeder bowl's sidewall or a livestock feeder container's sidewall. Yet in another embodiment of the invention, a plastic, rubber, or synthetic material-based outer skin layer may encapsulate or surround the antenna core (705) instead of the PVC pipe (701), depending on particular design and operational requirements.

FIG. 8 shows a rectangular feeder bowl-embedded rectangular RFID antenna apparatus in accordance with an embodiment of the invention. In this embodiment of the invention as shown in FIG. 8, an antenna outer surface (801) and an antenna feed point (803) surround a bordering perimeter of a rectangular feeder bowl's sidewall (807). By surrounding the bordering perimeter of the rectangular feeder bowl's sidewall (807), the rectangular feeder bowl-embedded rectangular RFID antenna apparatus (800) is able to accurately and precisely define an animal activity measurement zone (AMZ) as a feed-containing area (805). Therefore, false RFID tag access rates for animal monitoring purposes are substantially lowered by the structural uniqueness and the novelty of the rectangular feeder bowl-embedded rectangular RFID antenna apparatus (800) disclosed as an embodiment of the present invention. Furthermore, by structurally integrating a rectangular feeder bowl (e.g. 807) with a rectangular RFID antenna apparatus as a single physical unit, the portability of the AMZ defined by the feed-containing area is greatly improved over conventional RFID antennas that are mounted on a vertical post or placed on a non-portable ground object. Moreover, any relocations and reinstallations of livestock monitoring system in various livestock housings are greatly simplified with reduced tuning and installation time and effort for livestock farms.

Continuing with FIG. 8, the feed-containing area (805) may contain animal feed or water for livestock animals, such as cattle, chickens, pigs, ducks, and other livestock animals. In one embodiment of the invention, the rectangular feeder bowl and its sidewall (807) is made of durable plastic materials. In another embodiment of the invention, the rectangular feeder bowl and its sidewall (807) is made of rubber or synthesized materials. Yet in another embodiment of the invention, the rectangular feeder bowl and its sidewall (807) is made of metals or alloys.

Furthermore, in a preferred embodiment of the invention, the antenna outer surface (801) comprises a rectangular PVC pipe that encapsulates or surrounds an antenna core inside the antenna outer surface (801), as illustrated in FIG. 2. In another embodiment of the invention, the antenna outer surface (801) comprises an outer skin layer made of plastic, rubber, and/or synthetic materials that encapsulate or surround the antenna core inside the antenna outer surface (801), depending on particular design and operational requirements.

Moreover, as also described in association with FIG. 5 and FIG. 6, the antenna feed point (803) for the embodiment of the invention as shown in FIG. 8 is utilized to connect a signal source originating from an RFID reading device to the rest of the rectangular feeder bowl-embedded rectangular RFID antenna apparatus (800). Typically, an impedance matching circuit is integrated inside the rectangular feeder bowl-embedded rectangular RFID antenna apparatus (800), or is operatively connected to the rectangular feeder bowl-embedded rectangular RFID antenna apparatus (800) to achieve optimized signal propagation and RFID tag-reading sensitivities.

FIG. 9 shows a cross section (900) of an antenna outer surface (901) of a livestock feeder-embedded RFID antenna apparatus in accordance with an embodiment of the invention. In a preferred embodiment of the invention, the antenna outer surface (901) contains an antenna core (905), an impedance matching circuit (903), and a coaxial RF connector (907) inside the antenna outer surface (901). In the embodiment of the invention as shown in FIG. 9, the antenna core (905) is made of a 14 AWG copper wire with a diameter of approximately 0.0641 inches.

The antenna core (905) is electrically and operatively connected to the impedance matching circuit (903) that optimizes antenna efficiency and sensitivities by matching impedance between RF signals coming from an RFID reader device via the coaxial RF connector (907) and inherent device impedance of the livestock feeder-embedded RFID antenna apparatus. In the embodiment of the invention as shown in FIG. 9, an SMA female connector is used as the coaxial RF connector (907) and transmits RF signals coming from the RFID reader device, which is electrically and operatively connected to the livestock feeder-embedded RFID antenna apparatus. Furthermore, in the embodiment of the invention as shown in FIG. 9, a 1.5 inch-thick PVC pipe is used as the antenna outer surface (901) to encapsulate and protect all of the internal components (e.g. 903, 905, 907) from weather, dust, soil, and other operational-related wear-and-tear conditions.

In another embodiment of the invention, the livestock feeder-embedded RFID antenna apparatus may have a different diameter and a different PVC pipe thickness to accommodate a particular dimension (e.g. length, width, shape, and etc.) of a livestock feeder bowl's sidewall or a livestock feeder container's sidewall. Yet in another embodiment of the invention, a plastic, rubber, or synthetic material-based outer skin layer may encapsulate or surround the antenna core (905) instead of the PVC pipe (901), depending on particular design and operational requirements.

Various embodiments of livestock feeder-embedded RFID antenna apparatuses have been illustrated in FIGS. 1˜9 and described above. The present invention provides several advantages over conventional solutions. For example, one advantage of an embodiment of the present invention is that the livestock feeder-embedded antenna apparatus is able to accurately and precisely define an animal activity measurement zone (AMZ) around the sidewall of the livestock feeder by surrounding a bordering perimeter of the livestock feeder. As shown in several embodiments of the invention, the livestock feeder may be circular or rectangular in shape. Therefore, false RFID tag access rates for animal monitoring purposes are substantially lowered by the structural uniqueness and the novelty of the livestock feeder-embedded RFID antenna apparatus, as shown in various embodiments of the invention.

Furthermore, by structurally integrating a livestock feeder unit (e.g. a circular or rectangular feeder bowl, a circular or rectangular feeder container, and etc.) and a uniquely-structured RFID antenna apparatus as a single physical unit, the portability of the AMZ defined by the feed-containing area is greatly improved over conventional RFID antennas that are mounted on a vertical post or placed on a non-portable ground object. Moreover, any relocations and reinstallations of livestock monitoring system in various livestock housings are greatly simplified with reduced tuning and installation time and effort for livestock farms.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An RFID antenna apparatus comprising:
an antenna core forming a circular shape with a first end of the antenna core electrically connected to an antenna feed point and a second end of the antenna core also electrically connected to the antenna feed point;
an impedance matching circuit electrically connected to the antenna core;
a coaxial RF connector electrically connected to the impedance matching circuit and an RFID reading device to transmit RF signals;
the antenna feed point containing the coaxial RF connector;
an antenna outer surface made of a pipe or a protective outer skin layer, wherein the antenna outer surface encapsulates the antenna core, the impedance matching circuit, and the coaxial RF connector to provide weatherproofing and other wear-and-tear-related protection to internal components of the RFID antenna apparatus; and
a circular livestock feeder bowl with a sidewall and a livestock feed-containing area, wherein the circular livestock feeder bowl is structurally incorporated and embedded by the antenna outer surface that contains the antenna core, the impedance matching circuit, and the coaxial RF connector.

2. The RFID antenna apparatus of claim 1, wherein an operating frequency of the RFID antenna apparatus is approximately 900 MHz, and wherein a wavelength for the RF signals is approximately 1 foot.

3. The RFID antenna apparatus of claim 1, wherein the antenna outer surface is a PVC pipe with approximately 1.5-inch thickness.

4. The RFID antenna apparatus of claim 1, wherein the coaxial RF connector is an SMA female connector for operatively and electrically connecting the RFID reading device, the impedance matching circuit, and the antenna core.

5. The RFID antenna apparatus of claim 1, wherein a diameter of the antenna outer surface forming the circular shape is approximately 10 feet.

6. The RFID antenna apparatus of claim 1, wherein the antenna core comprises a 14 AWG copper wire with a wire diameter of approximately 0.0641 inches.

7. The RFID antenna apparatus of claim 1, wherein the circular livestock feeder bowl is made of plastic, rubber, or alloys.

8. The RFID antenna apparatus of claim 1, wherein the antenna outer surface also has a symmetrical or asymmetrical gap for highly-effective RFID tag reading range and antenna sensitivities around a perimeter of the circular livestock feeder bowl.

9. The RFID antenna apparatus of claim 1, wherein the livestock feed-containing area of the circular livestock bowl contains water of livestock feed

10. An RFID antenna apparatus comprising:
an antenna core forming a rectangular shape with a first end of the antenna core electrically connected to an antenna feed point and a second end of the antenna core also electrically connected to the antenna feed point;
an impedance matching circuit electrically connected to the antenna core;
a coaxial RF connector electrically connected to the impedance matching circuit and an RFID reading device to transmit RF signals;
the antenna feed point containing the coaxial RF connector;
an antenna outer surface made of a pipe or a protective outer skin layer, wherein the antenna outer surface encapsulates the antenna core, the impedance matching circuit, and the coaxial RF connector to provide weatherproofing and other wear-and-tear-related protection to internal components of the RFID antenna apparatus; and
a rectangular livestock feeder bowl with a sidewall and a livestock feed-containing area, wherein the rectangular livestock feeder bowl is structurally incorporated and embedded by the antenna outer surface that contains the antenna core, the impedance matching circuit, and the coaxial RF connector.

11. The RFID antenna apparatus of claim 10, wherein an operating frequency of the RFID antenna apparatus is approximately 900 MHz, and wherein a wavelength for the RF signals is approximately 1 foot.

12. The RFID antenna apparatus of claim 10, wherein the antenna outer surface is a PVC pipe with approximately 1.5-inch thickness.

13. The RFID antenna apparatus of claim 10, wherein the coaxial RF connector is an SMA female connector for operatively and electrically connecting the RFID reading device, the impedance matching circuit, and the antenna core.

14. The RFID antenna apparatus of claim 10, wherein a length of the antenna outer surface forming a side of the rectangular shape is approximately 5 feet.

15. The RFID antenna apparatus of claim 10, wherein the antenna core comprises a 14 AWG copper wire with a wire diameter of approximately 0.0641 inches.

16. The RFID antenna apparatus of claim 10, wherein the rectangular livestock feeder bowl is made of plastic, rubber, or alloys.

17. The RFID antenna apparatus of claim 10, wherein the antenna outer surface also has a symmetrical or asymmetrical gap for highly-effective RFID tag reading range and antenna sensitivities around a perimeter of the rectangular livestock feeder bowl.

18. The RFID antenna apparatus of claim 10, wherein the livestock feed-containing area of the rectangular livestock bowl contains water of livestock feed
